(19) United States
(12) Patent Application Publication
(10) Pub. No.: US 2014/0019493 A1
(43) Pub. Date: Jan. 16, 2014

(54) Software Application for Recording Trip Information

(71) Applicant: Paul William Gardiner, Hong Kong (HK)

(72) Inventor: Paul William Gardiner, Hong Kong (HK)

(21) Appl. No.: 13/549,418

(22) Filed: Jul. 14, 2012

(51) Int. Cl. G06F 17/30

(52) U.S. Cl. 707/812; 707/E17.044

(57) ABSTRACT

The subject software application combines a means for recording trip information contained in optical machine readable form using a handheld optical reader and for annotating additional information to such trip records to create trip data which can be collected, stored, statistically analysed and reported.

### Contents

1. Executive Summary

2. Terms and Definitions

3. Description of Software Application and Operation

### 1. Executive Summary

This software application is for the purpose of recording information on trips made by travellers, contributing to a database and aggregating such information, and enabling users to analyse the information in a variety of views or rankings

The benefits of this application are:
to record trip information efficiently using an optical reader as the primary input
to use such trip information for future reference and analysis of statistics
to rank trip data for individual users or groups of users based on selected criteria.

This application is in respect of the overall software application design and operation. This software application is intended for use on handheld devices but is applicable to all forms of computer devices.

### 2. Definitions and Terms used in this Application

(a) “Data”, “Field”, “Record”, “Database” have the meaning customarily used in the Information Technology sector.

(b) “Trip” refers to travel from an embarkation point to a destination.

(c) “Trip information” refers to factual data regarding a trip as illustrated in 3(a).

(d) “Trip Data” refers to all the information regarding trips, including additional commentary, opinion and other history or observations input by the Traveller. A Trip Record is the Trip Data referring to one specific Trip.

(e) “Traveller” and “Contributor” are interchangeable and refer to the person to whom the trip data refers, ie: the person who made the trips.

(f) “User” and “End-User” means the person using the application either to input data or to analyse results. The person who inputs the data to the application, is not necessarily the same person as the Traveller or Contributor, and could for example be an assistant, friend, relative or other acquaintance of the Traveller.

### 3. Description of System and Operation

This software application comprises:

(a) optical reader software which can capture optical machine readable data such as data contained in barcodes or other optically readable formats using a handheld device equipped with a camera or equivalent optical reader device. The application reads data from physical or electronic media such as the Traveller's paper or electronic boarding passes, and records it as a Trip Information in a trip record including but not restricted to data fields containing:

(i) the name of the Traveller

(ii) the destination

(iii) the embarkation point

(iv) the scheduled date of travel

(v) the scheduled time of departure

(vi) the scheduled time of arrival

(vii) the scheduled duration of the journey

(vi) the mode of transport (for example airline and flight number, or railroad and train number)

(vii) the class of travel

(viii) the seat number.

(b) the software application allows additional comment, opinion or other observations by the Traveller to be annotated to the trip record. The total record comprises the factual information described in 3(a) above together with the additional comment, opinion or other observations. The total record is referred to as the “Trip Data”.

(c) the software application stores the Trip Data on the handheld device. A User may use the application to look-up past Trip Data and to present the data in different formats or different rankings according to user-selected criteria.

(d) the application transmits the Trip Data to a remote database(s) by way of periodic synchronisation, or by a User manually initiating the transmission of data. In addition to uploading all Trip Data stored on the handheld device, the application synchronises the Traveller's Trip Data stored on the database to the handheld device.

(e) the Trip Data may be transmitted from any number of a User's handheld devices but each Trip Record is stored once. The application compares uploaded data and combines or eliminates duplicates so that only one record is stored for each trip by the Traveller.

(f) Trip Data also be input manually from any internet enabled device by entering the required information in the fields presented into an online data input form

(g) the software application allows User(s) to perform the following functions:

(i) lookup historical Trip Data for specific dates, specific destinations, etc

(ii) lookup historical Trip Data for particular modes of transport or particular transportation companies or carriers

(iii) rank the data according to the annotated data, including opinions or other commentary made by the Traveller

(iv) view Trip Data ranked according to aggregate opinions or other commentary input by Users

(h) the stored data may also be exported partially or completely to other systems or devices

(g) the software application can validate the Trip Information described in 3(a) by:

(i) comparing Traveller (Contributor) name to registered Contributor name

(ii) comparing departure time and arrival time to other trips submitted by the Traveller for the same date

(iii) validating the original embarkation point to the Traveller's registered home city.

I claim:

1. A software application comprising:
(a) A means of recording trip information contained in bar code or other optical machine readable format using a handheld device optical reader
(b) A means for using a handheld device to annotate trip data with commentary or opinions or other observations related to specific trips
(c) Storage on the handheld device of the said Trip Data, commentary, opinions and observations related to specific trips
(d) Transmission of said trip data at intervals to remote database(s)

2. A software application according to claim 1 which:
(a) aggregates trip data and allows individual contributors' to read and analyse their own historical trip records in various formats using a handheld device
(b) aggregates trip data and allows individual contributors to read and analyse their own historical trip records in various formats via the Internet from any other Internet-enabled device including personal computers.

3. A software application according to claim 1 which:
(a) aggregates trip data for all contributors and allows such trip data to be statistically analysed and displayed on a handheld device or other Internet enabled device including a personal computer
(b) aggregates trip data for all Contributors and ranks such data according to selected criteria and enables such rankings to be displayed on a handheld device or other Internet-enabled device including a personal computer
(c) aggregates trip data for all Contributors and enables such data to be exported partially or completely to other applications or other databases.

4. A software application according to claim 1 which:
(a) can validate the identity of the Contributor and
(b) can check the validity of contributed Trip Data.
